(19) United States
(12) Patent Application Publication
(10) Pub. No.: US 2023/0403993 A1
(43) Pub. Date: Dec. 21, 2023

(54) PLANTER EDGING SYSTEM

(71) Applicant: Logic Manufactured Bespoke Limited, Billingham, Cleveland (GB)

(72) Inventors: Stephen Allen, Billingham, Cleveland (GB); Rick Jackson, Billingham, Cleveland (GB)

(21) Appl. No.: 18/249,594

(22) PCT Filed: Oct. 20, 2021
(86) PCT No.: PCT/GB2021/052705

§ 371 Date: Apr. 19, 2023

(30) Foreign Application Priority Data
Oct. 20, 2020 (GB) 2016654.2

(51) Int. Cl. A01G 9/28

(52) U.S. Cl. CPC A01G 9/28

(57) ABSTRACT

A planter edging system comprising a set of edging panels arranged for end-to-end engagement to form at least part of a boundary of a planting area. Each edging panel comprises: a planter wall having an inner surface exposed to contents of the planting area, in use, the inner surface having a pair of longitudinal edges connected by side edges; and a respective end flange extending along each side edge of the inner surface of the planter wall, each end flange defining an outwardly-directed mating face arranged to engage a corresponding mating face of an adjacent edging panel, each mating face including multiple locking apertures. The planter edging system further comprises: a gusset that is anchored within the planting area, in use, and is configured to hold one or more of the edging panels upright; a panel connector comprising multiple locking protrusions, each locking protrusion being arranged for insertion through a respective pair of aligned locking apertures of engaged end flanges of adjacent edging panels; and a locking member arranged to engage at least one of the locking protrusions of the panel connector to resist retraction of the or each locking protrusion through the respective locking apertures.

### CROSS-REFERENCE TO RELATED APPLICATIONS

This application is a national stage of, and claims priority to, Patent Cooperation Treaty Application No. PCT/GB2021/052705, filed on Oct. 20, 2021, which application claims priority to United Kingdom Application No. GB2016654.2, filed on Oct. 20, 2020, which applications are hereby incorporated herein by reference in their entireties.

### BACKGROUND

An increasing desire to incorporate green spaces into urban environments has driven the development of commercial planters, in which a substantial volume of soil or other growing medium is contained by a rigid boundary wall to create a large-scale planting area.

The scale of commercial planters entails that their boundary walls effectively act as retaining walls that must withstand the load of many tonnes of material within. Commercial planters must also be robust in view of their public position, and may even be vulnerable to vehicle impacts in some applications. Commercial planters are therefore entirely distinct from consumer garden border systems for lawns, raised beds and the like, which are substantially free from such load considerations. By way of example, a consumer garden border may be of the order of 200 mm in height, and typically no more than 250 mm, whereas commercial planters are typically 600-700 mm in height and heights of 1.2 m or more are known.

Whilst in principle a commercial planter could be created using a wall of brick or similar, constructing a planter in this way is labour intensive and may not offer the desired aesthetic. To address this, some commercial planters instead have boundary walls formed from a series of steel edging panels coupled end-to-end to form a closed loop that encloses a planting area. Such edging systems can be erected in a fraction of the time taken to construct a brick wall and can provide a substantially smooth, continuous outer wall for a clean, modern aesthetic.

In known edging systems, neighbouring panels can be coupled using complementary interlocking formations at the end of each panel, although this creates discontinuity in the outer surface of the resulting boundary wall and thereby damages aesthetics. It is therefore preferred to secure panels to one another internally, for example using bolts. Assembly of such systems is time-consuming for site operatives, however.

As edging panels are generally formed from sheet metal, to provide the required strength in the boundary wall it is typically necessary to use bracing elements, or ‘structural gussets’, that transfer loads from the wall to a foundation and thereby stiffen the wall and increase its capacity to resist bending under the weight of the material contained in the planting area. Such gussets may, for example, be welded to an inner surface of the boundary wall to extend perpendicularly inwardly from that inner surface to attach to a foundation, typically via bolts or other mechanical means. The gusset must usually extend substantially to the top of the boundary wall to ensure that no weak areas arise that could deform in service.

The need to secure the gussets to a foundation adds time to the assembly process on site. Moreover, commercial planters are often installed in contexts in which a suitable foundation to which a gusset may bolted is not readily available, for example on roofs or balconies, meaning that a foundation must be created in an additional construction process.

### SUMMARY

In an implementation, the present disclosure describes a planter edging system comprising a set of edging panels arranged for end-to-end engagement to form at least part of a boundary of a planting area. Each edging panel includes: a planter wall having an inner surface exposed to contents of the planting area, in use, the inner surface having a pair of longitudinal edges connected by side edges; and a respective end flange extending along each side edge of the inner surface of the planter wall, each end flange defining an outwardly-directed mating face arranged to engage a corresponding mating face of an adjacent edging panel, each mating face including multiple locking apertures. The planter edging system further includes: a gusset that is anchored within the planting area, in use, and is configured to hold one or more of the edging panels upright; a panel connector comprising multiple locking protrusions, each locking protrusion being arranged for insertion through a respective pair of aligned locking apertures of engaged end flanges of adjacent edging panels; and a locking member arranged to engage at least one of the locking protrusions of the panel connector to resist retraction of the or each locking protrusion through the respective locking apertures.

In an implementation, the gusset may provide the strength required by commercial planter systems, while the panel connector and the locking member, together with the configuration of the mating faces and locking apertures of the panels, may provide for a convenient and straightforward assembly process that can be completed quickly on site with minimal tools. In particular, in an implementation, the inclusion of multiple locking protrusions on a common panel connector may allow each of the locking apertures to be engaged simultaneously, thus simplifying and accelerating assembly. In an implementation, assembly may be further accelerated if the locking member is configured to engage each locking protrusion of the panel connector, such that only one locking member may secure adjacent panels together in a single assembly operation.

The locking member may be configured to engage the or each locking protrusion by wedging interaction and/or may be arranged for a press-fit with the or each locking protrusion. In another implementation, locking member may include one or more locking member apertures, each locking member aperture being arranged to receive a respective locking protrusion and comprising a formation arranged to engage an opening in the respective locking protrusion. In an implementation, the or each locking protrusion opening may have converging sides to define a tapered profile, in which case the or each locking member aperture formation may be arranged to be pressed into progressive engagement with the converging sides of the respective locking protrusion opening to generate a retention force that holds the locking member in engagement with the or each locking protrusion. These arrangements may allow the locking member to be secured to the locking protrusions, and thus lock the associated edging panels together, with pressing forces alone, obviating the need for bolts or screws, for example.

In an implementation, each locking aperture may comprise an elongate slot. For example, the slots may be elongate in a direction substantially parallel to the respective side edge of the edging panel. Correspondingly, in an implementation, each locking protrusion may comprise a tab, for example defined by a flange of the panel connector.

In some implementations, the panel connector may comprise a connector plate from which the locking protrusions extend.

In some embodiments, each end flange comprises at least one alignment aperture arranged to align with a corresponding alignment aperture of an adjacent edging panel, in use. At least one of the alignment apertures of each end flange may be non-circular, for example polygonal. Similarly, the locking member may comprise at least one alignment aperture that is configured to align with corresponding alignment apertures in the associated engaged end flanges when the locking member is in a locked position. In addition, the panel connector may comprise at least one alignment aperture configured to align with corresponding alignment apertures in the associated end flanges when the locking protrusions are fully inserted into the locking apertures.

The planter edging system may comprise a base plate arranged to be loaded by contents of the planting area, in use, to anchor the gusset. This beneficially enables the edging system to be assembled without being mechanically secured to the surface on which it rests, for example by bolting elements of the system to that surface. It also avoids having to provide a foundation in situations in which the system cannot be secured directly to the surface on which the system is installed, as in known arrangements.

The base plate is optionally arranged to engage a surface on which the planter edging system is installed. At least one of the base plate and the gusset may comprise a formation enabling coupling of the base plate and the gusset, thereby avoiding have to weld or bolt these components together and simplifying assembly whilst maximising strength in the final arrangement. For example, the gusset may comprise a protrusion such as a flange that is arranged to be received in an opening of the base plate, such as a slot, to couple the gusset to the base plate. Alternatively, the base plate may be integral with the gusset. In another alternative, the base plate may be integral with one of the edging panels, for example being defined by a flange of the panel.

The planter edging system may comprise a set of base plates having a combined surface area that is at least 40%, and optionally half, of a combined surface area of the planter walls of the set of edging panels. This ensures that the load of the planter contents bearing down on the base plates generates a sufficient anchoring force, via the gussets, to hold the edging panels upright against the weight of the same planter contents bearing against the planter walls.

The panel connector may be integral with the gusset, such that the gusset acts both to join adjacent edging panels and to hold those panels upright. Alternatively, the gusset may be integral with an end flange of one of the edging panels.

Each edging panel may comprise a longitudinal flange extending along a longitudinal edge of the edging panel, in which case respective longitudinal flanges of engaged edging panels may abut, in use. Each longitudinal flange may be substantially orthogonal to its associated end flanges.

Each end flange may be substantially orthogonal to the inner surface of the associated planter wall.

One or more of the edging panels, the locking member, the gusset, the base plate and the panel connector are optionally formed from sheet metal, such that the components are straightforward and inexpensive to manufacture.

The inner surface of the planter wall of at least one of the edging panels may be substantially planar. Equally, the panels may have curved planter walls.

Respective outer surfaces of the planter walls of engaged edging panels may be substantially continuous with each other, in use.

Another aspect of the invention provides a planter edging system comprising a set of edging panels arranged for end-to-end engagement to form at least part of a boundary of a planting area. Each edging panel comprises: a planter wall having an inner surface exposed to contents of the planting area, in use, the inner surface having a pair of longitudinal edges connected by side edges; and a respective end flange extending along each side edge of the inner surface of the planter wall, each end flange defining an outwardly-directed mating face arranged to engage a corresponding mating face of an adjacent edging panel. The planter edging system further comprises: a set of panel connector assemblies, each panel connector assembly being configured to lock a respective pair of engaged end flanges of adjacent edging panels together; a set of base plates arranged to be loaded by contents of the planting area, in use, wherein the base plates of the set have a combined surface area that is at least 40%, and optionally half, of a combined surface area of the inner surfaces of the edging panel planter walls; and a set of gussets that are each anchored to a respective base plate, in use, each gusset being configured to hold one or more of the edging panels upright. This ratio of the surface areas ensures that the load of the planter contents bearing down on the base plates generates a sufficient anchoring force to hold the edging panels upright against the weight of the same planter contents, via the gussets.

Another aspect of the invention provides a method of constructing a planter edging system. The system comprises a set of edging panels arranged for end-to-end engagement to form at least part of a boundary of a planting area. Each edging panel comprises end flanges defining respective outwardly-directed mating faces arranged to engage corresponding mating faces of adjacent edging panels, each mating face including multiple locking apertures. The method comprises: anchoring a gusset connected to one or more of the edging panels within the planting area; engaging the respective mating faces of adjacent edging panels such that the locking apertures of the respective end flanges align; inserting multiple locking protrusions of a panel connector through respective pairs of aligned locking apertures simultaneously; and engaging a locking member with at least one of the locking protrusions to resist subsequent retraction of the or each locking protrusion through the respective locking apertures.

A related aspect of the invention provides a method for making a planter edging system. The system comprises a set of edging panels arranged for end-to-end engagement to form at least part of a boundary of a planting area. The method comprises cutting a blank for a first edging panel from a piece of sheet material, cutting a blank for a second edging panel from a piece of sheet material, and folding each of the blanks for the first and second edging panels so that each of the edging panels define: a planter wall having an inner surface exposed to contents of the planting area, in use, the inner surface having a pair of longitudinal edges connected by side edges; and a respective end flange extending along each side edge of the inner surface of the planter wall, each end flange defining an outwardly-directed mating face arranged to engage a corresponding mating face of an adjacent edging panel, each mating face including multiple locking apertures. The method further comprises: cutting a blank for a gusset from a piece of sheet material; cutting a blank for a panel connector from a piece of sheet material, and folding the blank to define multiple locking protrusions, each locking protrusion being arranged for insertion through a respective pair of aligned locking apertures of engaged end flanges of adjacent edging panels; and cutting a blank for a locking member from a piece of sheet material, the locking member being arranged to engage at least one of the locking protrusions of the panel connector to resist retraction of the or each locking protrusion through the respective locking apertures.

A further aspect of the invention provides a method of constructing a planter edging system. The system comprises a set of edging panels arranged for end-to-end engagement to form at least part of a boundary of a planting area. Each edging panel comprises end flanges defining respective outwardly-directed mating faces arranged to engage corresponding mating faces of adjacent edging panels. The method comprises: engaging the respective mating faces of adjacent edging panels; locking the engaged end flanges of adjacent edging panels together; loading a set of base plates with contents of the planting area, such that a combined loaded surface area of the base plates corresponds to at least 40%, and optionally half, of a combined surface area of the inner surfaces of the edging panel planter walls; and anchoring a respective gusset to each base plate, each gusset being connected to one or more of the edging panels to hold the or each edging panel upright.

A related aspect of the invention provides a method for making a planter edging system. The system comprises a set of edging panels arranged for end-to-end engagement to form at least part of a boundary of a planting area, a set of gussets that are each configured to hold one or more of the edging panels upright, in use, and a set of base plates arranged to be loaded by contents of the planting area. The method comprises cutting a blank for a first edging panel from a piece of sheet material, cutting a blank for a second edging panel from a piece of sheet material, and folding each of the blanks for the first and second edging panels so that each of the edging panels define: a planter wall having an inner surface exposed to contents of the planting area, in use, the inner surface having a pair of longitudinal edges connected by side edges; and a respective end flange extending along each side edge of the inner surface of the planter wall, each end flange defining an outwardly-directed mating face arranged to engage a corresponding mating face of an adjacent edging panel. The method further comprises: for each gusset of the set, cutting a blank for the gusset from a piece of sheet material; and for each base plate of the set, cutting a blank for the base plate from a piece of sheet material, such that the base plates of the set have a combined surface area that is at least 40% of a combined surface area of the inner surfaces of the edging panel planter walls.

It will be appreciated that preferred and/or optional features of each aspect of the invention may be incorporated alone or in appropriate combination in the other aspects of the invention also.

### BRIEF DESCRIPTION OF THE DRAWINGS

In order that it may be more easily understood, an embodiment of the invention will now be described, by way of example only, with reference to the following drawings, in which like features are assigned like numerals, and in which:

FIG. 1 shows a cut-through of an assembled planter edging system;

FIGS. 2a and 2b show, respectively, front and rear perspective views of an edging panel of the system of FIG. 1;

FIG. 3 shows a flat pattern or ‘blank’ of the edging panel of FIGS. 2a and 2b;

FIGS. 4a and 4b show, respectively, front and rear perspective views of a support member of the system of FIG. 1;

FIG. 5 shows a flat pattern or ‘blank’ of the support member of FIGS. 4a and 4b;

FIG. 6 shows a perspective view of a base plate of the system of FIG. 1;

FIG. 7 shows a perspective view of the support member of FIGS. 4a and 4b assembled with the base plate of FIG. 6;

FIG. 8 shows a perspective view of a locking member of the system of FIG. 1;

FIG. 9 shows a flat pattern or ‘blank’ of the locking member of FIG. 8;

FIGS. 10 to 13 show a sequence of assembling part of the system of FIG. 1; and

FIG. 14 is a detail view of a locking arrangement of the system of FIG. 1.

### DETAILED DESCRIPTION

The present disclosure describes planter edging systems for commercial planters that may be self-supporting and may be erected quickly and with minimal tools. In particular, in some implementations, the edging systems of the present disclosure may offer bolt-less assembly by providing connector assemblies that can create robust joints between neighbouring panels using interlocking formations that may be pressed into engagement and may be self-retaining thereafter.

In some implementations, the edging system includes base plate arrangements that interact with the contents of the planter to support the walls of the edging system without separate foundations.

In some implementations, the edging systems of the present disclosure include the smooth exterior wall and general aesthetics that are desired for such edging systems.

According to the principles of the present disclosure, FIG. 1 shows part of a commercial planter 10 that is composed of a rectangular boundary wall 12 and a planting area 14 that is enclosed by the boundary wall 12. The boundary wall 12 is defined, at least in part, by a planter edging system 16 according to an implementation of the present disclosure. The edging system 16 shown in FIG. 1 comprises a series of edging panels 18 arranged end-to-end to form three sides of the rectangular boundary wall 12.

It will be appreciated that the boundary wall 12 may be completed by further edging panels that are not shown in FIG. 1. Equally, the edging system 16 could be supplemented by another wall to complete the boundary wall 12. For example, the edging system 16 may be installed against a building or another structure, such that an external wall of the building or structure closes the rectangle and thus defines part of the boundary wall 12. Accordingly, planter edging systems of embodiments of the invention may define an entire boundary wall of a commercial planter 10, or part of a boundary wall.

It is noted that the rectangular shape of the boundary wall 12 shown in FIG. 1 is merely an example, and edging systems of the present disclosure can be configured to create boundary walls of various shapes.

FIG. 1 shows the edging system 16 installed on a flat horizontal surface 20, which in this example may be a roof of a building. A series of square tiles or slabs 22 are arranged around the outer periphery of the edging system 16 to create a walkway that hides and protects the underlying roof 20. No additional foundation or supporting structure is provided, and the edging panels 18 rest directly on the roof 20. In the exemplary implementation of FIG. 1, foundational support to the boundary wall 12 is provided through interaction between components of the edging system 16 and the contents of the planting area 14.

A gusset assembly 24 is provided at each interface between adjacent edging panels 18. Each gusset assembly 24 extends into the planting area 14 and provides the dual functions of securing neighbouring panels 18 to one another and holding those panels 18 upright against the load of the planter contents, in use. The edging panels 18 and gusset assemblies 24 are arranged in a repeating pattern, such that each panel 18 and its associated gusset assembly 24 collectively define a boundary wall section.

Each gusset assembly 24 comprises: a triangular gusset member 26 that extends in a generally vertical plane that is orthogonal to the associated edging panels 18; a generally horizontal base plate 28 that engages the roof 20 and is coupled to the gusset member 26; and a locking member 30 that secures the gusset member 26 to the edging panels 18. Each of these components is described in more detail below. In overview, each gusset member 26 secures to an interface between adjacent edging panels 18 to couple those panels 18 and to transfer loads from the panels 18 to the base plate 28. The base plate 28, in turn, is sized and positioned such that the weight of soil or other material within the planter 10 bearing down on the base plate 28 is sufficient to provide the necessary stabilising force to hold the associated edging panels 18 in position. In this way, the edging system 16 is self-supporting and dispenses with the need for a separate foundation or for fastening to the surface 20 upon which the system 16 is installed, thereby greatly accelerating installation relative to known systems.

In some implementations, each component of the edging system 16 may be formed from sheet metal that is cut to a flat pattern or ‘blank’ and then folded and surface-treated as necessary to produce the final component, with no further manufacturing operations being required. The edging system 16 may be therefore relatively inexpensive to manufacture. In such implementations, the components are formed from mild steel sheet of 3 mm thickness. This may be treated, for example galvanised or painted, as required for protection from the elements.

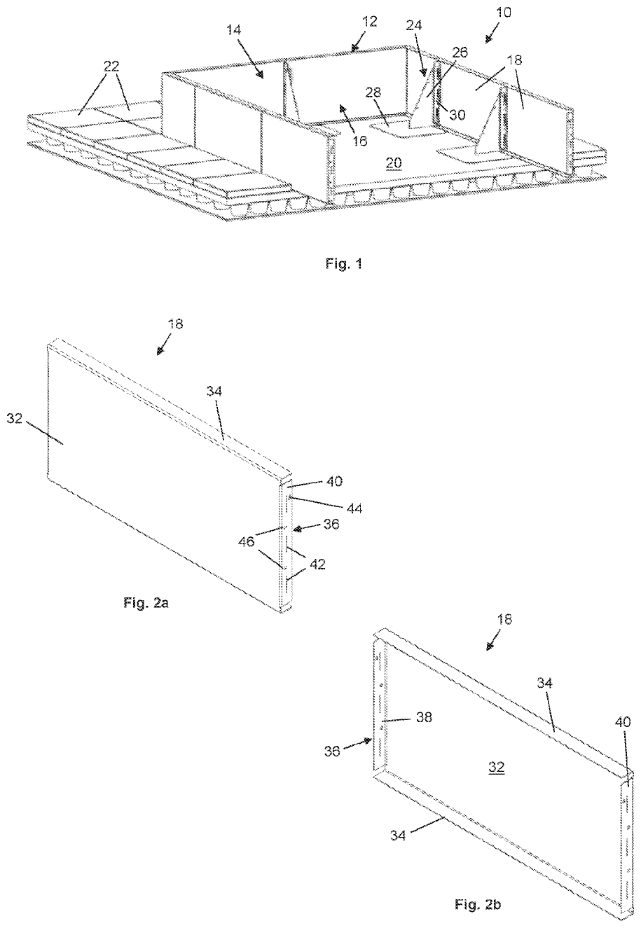

FIGS. 2a and 2b show an individual edging panel 18 in front and rear views respectively. The edging panel 18 comprises a generally planar, oblong planter wall 32 whose longer edges extend longitudinally when assembled with other edging panels 18, such that the longitudinal edges correspond to a top and a bottom of the panel. The longitudinal edges are connected by side edges corresponding to ends of the panel.

References below to features that extend “vertically” or “horizontally” refer to the orientation of the edging panel 18 when installed, “horizontal” therefore corresponding to “longitudinal”.

Each longitudinal edge of the planter wall 32 has a respective longitudinal flange 34 extending along the entirety of the edge. The longitudinal flanges 34 extend from an inner surface of the planter wall 32, the longitudinal flanges 34 being substantially orthogonal to the inner surface and thus parallel to each other.

Correspondingly, each side edge has a respective end flange 36 extending along most of the edge, each end flange 36 extending orthogonally to and inwardly from the inner surface of the planter wall 32 and thus orthogonally to the longitudinal flanges 34.

The four flanges 34, 36 of the edging panel 18 are of equal length, such that the panel 18 has the general form of a shallow cuboidal tray. The flange 34,36 therefore form a skirt extending around the flat front face of the edging panel 18.

The major surfaces of each end flange 36 define an inner surface 38, which is directed inwardly and towards the corresponding surface of the opposed end flange 36 of the panel, and an outwardly-directed engagement or mating face 40, which is configured to engage a corresponding mating face 40 of another edging panel.

Each end flange 36 comprises a series of three identical vertically-extending end flange slots 42 that are regularly-spaced along a vertical centreline of the end flange 36. A triangular opening 44 is disposed beside the uppermost end flange slot 42, on the opposite side of the end flange slot 42 to the fold of the flange. The end flange 36 includes two further circular openings 46, each positioned in a respective space between adjacent end flange slots 42. The end flange slots 42 enable engaged mating faces 40 to be secured to one another using a gusset member 26 and a locking member 30, while the triangular opening 44 and circular openings 46 act as alignment apertures that are used to confirm locking engagement of the locking member 30 with the gusset member 26, as described in more detail later.

The end flanges 36 terminate short of the ends of their respective side edges and are folded such that they are offset towards the centre of the edging panel 18 to occupy space between the longitudinal flanges 34, which therefore overhang the end flanges 36. Each mating face 40 extends in a common vertical plane with a respective end of each longitudinal flange. The end flanges 36 are therefore recessed to lie entirely within an envelope defined by the longitudinal flanges 34 in this embodiment. Accordingly, when the end flanges 36 of a pair of adjacent edging panels 18 engage, the respective longitudinal flanges 34 of the panels 18 abut one another directly to form substantially continuous surfaces.

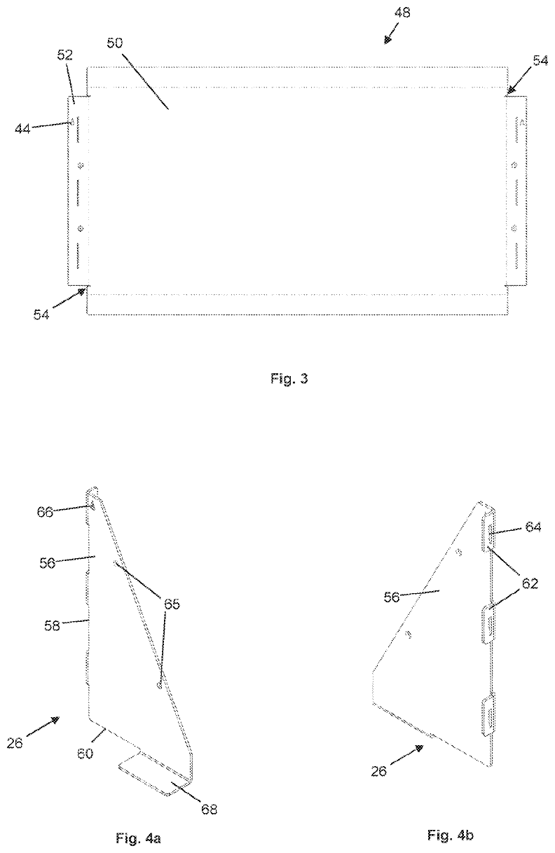

This is achieved using the flat pattern 48 for the edging panel 18 shown in FIG. 3, which represents the shape to which a section of sheet metal is cut, for example by laser cutting, before folding the flanges to create the final shape of the edging panel. This shape takes the general form of main oblong 50 having a smaller rectangular tab 52 on each of the longer sides of the main oblong 50, each of which tabs 52 will become an end flange 36. The slots and openings of the end flanges 36 are therefore cut into the tabs 52. Aside from the triangular openings 44, the flat pattern 48 has symmetry about both horizontal and vertical axes.

Portions of the main oblong 50 extending above and below the tabs 52 in FIG. 3 will define the longitudinal flanges 34. In this respect, dashed lines in FIG. 3 represent fold lines along which the flanges are formed and which therefore define the edges of the planter wall 32.

FIG. 3 reveals recesses 54 that are cut into the side edges at each end of each end flange 36. These recesses 54 act as reliefs that enable the fold lines for the end flanges 36 to be moved towards the centre of the panel 18 and inboard of the extremities of the portions of the main oblong 50 that will become the longitudinal flanges 34. This in turn allows the end flanges 36 to fold into a space between the longitudinal flanges 34, such that the mating faces 40 of each end flange 36 align with corresponding ends of the longitudinal flanges 34.

When the panel 18 is assembled with other edging panels 18 such that its planter wall 32 defines a portion of the boundary wall 12, the inner surface 38 of each planter wall 32 faces into the planting area 14 and thus engages the soil or other material contained in the planter 10. Meanwhile, an outer surface of the planter wall 32 on an opposite side to the inner surface 38 defines an exterior of the respective boundary wall section, in use. The outer surface is generally smooth and featureless and, by virtue of the recessed end flanges 36, the edging panel 18 is arranged to engage neighbouring panels 18 such that the outer surfaces of the respective planter walls 32 connect to form a substantially smooth and continuous surface that extends around the boundary wall 12.

Moving on to FIGS. 4a and 4b, the gusset member 26 is shown in front and rear views. The gusset member 26 has a main section defining a gusset plate 56 having the general form of a scalene right-angled triangle having a pair of orthogonal legs connected by a hypotenuse, albeit with truncated vertices at each end of the hypotenuse.

An edge of the gusset plate 56 corresponding to the longer leg of the triangle defines a first gusset plate edge 58, while the edge of the gusset plate 56 corresponding to the shorter leg of the triangle defines a second gusset plate edge 60.

The first gusset plate edge 58 includes a series of three locking tabs or flanges 62 that extend orthogonally to the gusset plate 56 in a common vertical plane. The uppermost locking flange 62 coincides with the top of the first gusset plate edge 58. The truncation of the gusset plate 56 at this corner creates a short additional edge that is normal to the first gusset plate edge 58, the purpose of this truncation being to increase the rigidity of the uppermost locking flange 62.

The lowermost locking flange 62 is spaced from the lower end of the first gusset plate edge 58, while the third locking flange 62 is positioned midway between the uppermost and lowermost locking flanges 62.

Each locking flange 62 includes a vertical engagement slot 64. An upper portion 64a of each engagement slot 64 is generally rectangular, and below this portion the sides of the slot converge downwardly to a point.

The locking flanges 62 are sized and positioned in a complementary manner to the end flange slots 42 of an edging panel end flange 36, such that all three locking flanges 62 can be inserted simultaneously into respective end flange slots 42 of an end flange 36. The locking flanges 62 are sized for a close sliding fit in the end flange slots 42 to minimise play of the flanges in the slots 42.

Adjacent to the fold of the uppermost locking flange 62, the gusset plate 56 includes a triangular opening 66 that is identical to those of the end flanges 36 of the edging panels 18, and moreover is arranged to align with the corresponding apertures of engaged end flanges 36 when securing two panels 18 together, as shall become clear later.

Two circular holes 65 are spaced along the hypotenuse of the gusset plate 56, these holes allowing for reinforcement strings or wires to be attached to the gusset member 26 as may be desired in use.

The second gusset plate edge 60 includes a base flange 68 at an opposite end of the second gusset plate edge 60 to the right-angled vertex. This end of the second gusset plate edge is truncated to create a short vertical edge that connects with the hypotenuse of the gusset plate triangle, again to enhance rigidity in the base flange 68. The base flange 68 is considerably larger than the locking flanges 62, in this example being on the order of the combined size of all three locking flanges 62.

The base flange 68 extends orthogonally to the gusset plate 56, from an opposite side of the gusset plate 56 to the locking flanges 62. As the first and second gusset plate edges 58, 60 are orthogonal to one another, it follows that the base flange 68 extends in a plane that is orthogonal to the common plane in which the locking flanges 62 extend. Arranging the base flange 68 and the locking flanges 62 on opposite sides of the gusset plate 56 enhances balance of the gusset member 26 when upright.

The gusset member 26 is sized to provide sufficient structural support to the edging plates to which it is coupled, to provide sufficient bracing and to transfer loads from the edging panel 18 to the base plate 28 effectively. In general terms, the first gusset plate edge 58 defines a height of the gusset member 26, which is generally at least 80% of the height of the edging panel, and often substantially the same height at the edging panel. This ensures that the uppermost parts of the edging panel 18 are supported against bending in use. Meanwhile, the second gusset plate edge 60 defines a depth of the gusset member 26, which should be at least 50% of the height of the associated edging panels 18.

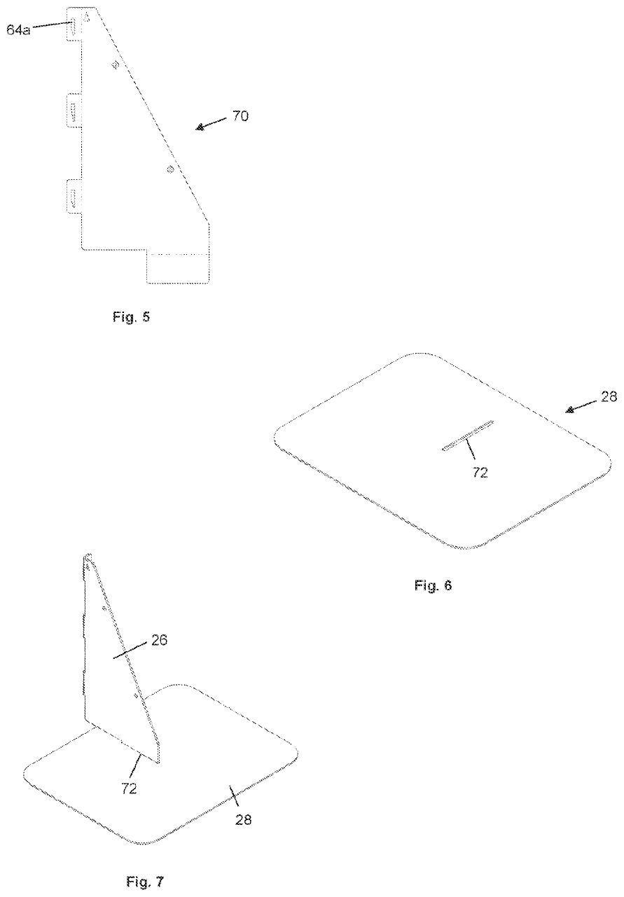

FIG. 5 shows the flat pattern 70 for the gusset member 26, which indicates that the fold lines for the locking flanges 62 are substantially colinear with the first gusset plate edge 58, on which those folds are formed. In slight contrast, the fold line for the base flange 68 is parallel to but spaced below the second gusset plate edge 60, such that a vertical offset exists between an upper surface of the base flange 68 and the second gusset plate edge 60 in the completed gusset member 26. This offset allows the second gusset plate edge 60 to engage an upper surface of the base plate 28 while the upper surface of the base flange 68 engages a lower surface of the base plate 28.

FIG. 6 shows the base plate 28 in isolation, which illustrates that the base plate 28 is generally rectangular and close to being square, but with rounded corners for safety. As noted above, the base plate 28 serves to anchor the gusset assembly 24 and the associated edging panels 18 in the soil or other substrate contained in the planter 10, and to this end is sized to provide a sufficient anchoring force to hold the associated edging panels 18 upright by virtue of the weight of soil acting on the base plate 28. In general terms, noting also that each base plate 28 contributes support to multiple edging panels 18, this means that, in some implementations, the base plates 28 of the edging system 16 have a combined surface area that is at least 40% of a combined surface area of the edging panels 18 of the system 16, and typically at least half of the combined edging panel surface area. In some implementations, the combined surface area of the base plates may be relatively evenly distributed across the individual panels, and in some implementations that base plates 28 are identical to one another. In some implementations, the above-described combined surface area values may be reduced if part of the boundary wall 12 is defined by a wall of a building to which the edging system 16 is attached, to the extent that the building imparts rigidity to the edging system 16.

In some implementations, an elongate base plate slot 72 extends along a widthwise centreline of the base plate 28, the slot being inboard of the edges of the base plate 28 and closer to one side of the base plate 28 than to the other. The dimensions of the base plate slot 72 correspond to those of the base flange 68 of the gusset member 26, such that the base plate slot 72 is configured to receive the base flange 68 in a sliding fit whilst accommodating the fold of the base flange 68 to enable the base flange 68 to be rotated to engage the underside of the base plate 28 once fully inserted.

FIG. 7 shows the gusset member 26 assembled with the base plate 28, with the base flange 68 inserted through the base plate slot 72 and engaged with the underside of the base plate 28. To reach this arrangement, the base plate 28 is initially oriented orthogonally to the position shown in FIG. 7, such that it is parallel to the gusset plate 56 and with the base plate slot 72 aligned with the base flange 68 of the gusset member 26. The base flange 68 is then inserted into the base plate slot 72. Once the base flange 68 is fully inserted, the base plate 28 is rotated about the fold of the base flange 68 into the final position shown in FIG. 7, which is enabled by the offset of the base flange 68 from the second gusset edge 60.

In some implementations, the base plate 28 is held in a horizontal position by the weight of soil loaded onto it, while the gusset member 26 is held in a vertical orientation due to its being attached to edging panels 18. Accordingly, while the gusset member 26 and base plate 28 are held in these orientations, the base flange 68 prevents disengagement of the gusset member 26 from the base plate 28 and thus anchors the gusset member 26 and any edging panels 18 to which it is attached. Meanwhile, the closed nature of the base plate slot 72 prevents movement of the gusset member 26 in a horizontal plane and thus enhances the rigidity of the assembly.

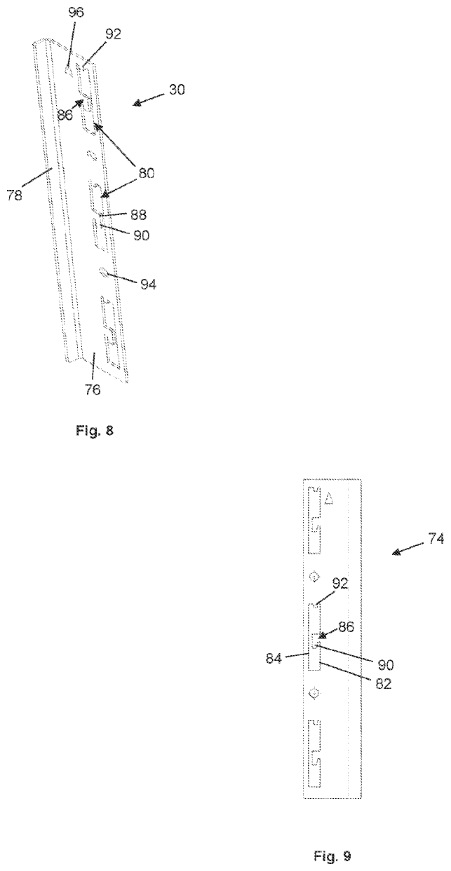

FIG. 8 shows the locking member 30 that is used to secure the gusset member 26 to a pair of engaged end flanges 36 of adjacent edging panels 18. FIG. 9 shows the corresponding flat pattern 74 for the locking member 30.

The locking member 30 is defined by an elongate oblong locking plate 76 having a flange 78 extending along one of its long sides, such that the locking member 30 is L-shaped in transverse section. The flange 78 is provided to ease handling of the locking member 30 when assembling the edging system 16, and so defines a handle.

A series of engagement apertures 80 is disposed adjacent to the opposite longer side of the locking plate 76 to the handle 78, the series extending along an axis parallel to the longer side edge, which is vertical in use. Each engagement aperture 80 is generally oblong, having vertical long sides and horizontal short sides. A respective one of the long sides closest to the handle 78 defines an inner edge 82 of the engagement aperture 80, while the other of the long sides correspondingly defines an outer edge 84 of the engagement aperture 80.

Each engagement aperture 80 includes an engagement arm or ‘tooth’ 86 projecting inwardly from a central part of the inner edge 82 of the aperture 80, the engagement arm 86 extending first horizontally and then downwardly such that the arm 86 is L-shaped in plan view, defining a main portion 88 of the arm 86 from which depends a downwardly-extending finger 90. The finger 90 is aligned with the end of the main portion 88 and extends substantially centrally between the inner and outer edges 82, 84 of the engagement aperture 80. Accordingly, gaps are defined on each side of the finger 90, those gaps being no smaller than the thickness of the locking flanges 62 of the gusset member 26.

The overall vertical height of the engagement arm 86, namely the combined height of the main portion 88 and the finger 90, is smaller than the vertical height of the upper rectangular portions of the engagement slots 64 of the locking flanges 62, such that the engagement arms 86 can be inserted through the upper portions of the engagement slots 64.

A further projection extends downwardly from the short top edge of each engagement aperture 80, this projection being generally square in plan view and defining a guide formation 92 that is configured to guide an upper end of a locking flange 62, in use. Accordingly, a vertical edge of the guide formation 92 closest to the inner edge 82 of the engagement aperture 80 is aligned with a corresponding edge of the finger 90 of the engagement arm 86, such that a locking flange 62 can be received between the guide formation 92 and the inner edge 82 of the aperture 80.

The engagement apertures 80 are arranged in a formation corresponding to that of the locking flanges 62 of the gusset member 26, such that the locking member 30 can be received onto the locking flanges 62 by insertion of each locking flange 62 through a respective engagement aperture 80 simultaneously.

Between each pair of engagement apertures 80 is a circular opening 94 corresponding in both size and position to the circular openings 46 of the end flanges 36 of the edging panels 18 that act as alignment apertures. Accordingly, when the locking member 30 is secured in the correct position, these circular openings 94 align with those of the end flanges 36 of the associated edging panels 18 to confirm the correct position for the locking member 30.

Correspondingly, between the uppermost engagement aperture 80 and the handle 78 is a triangular opening 96 corresponding in size, shape and position to the respective triangular openings 44, 66 of the gusset member 26 and the end flanges 36 so that, when the locking member 30 is secured in the correct position, the respective triangular openings 44, 66, 96 align to confirm the correct position for the locking member 30. It is noted that the shape of the triangular openings 44, 66, 96 allows the orientation to be verified.

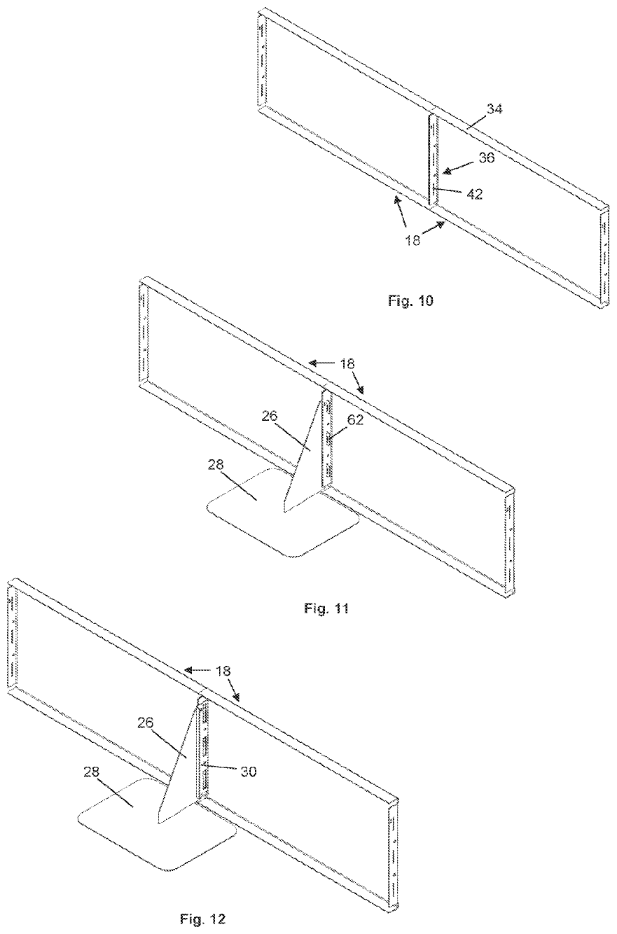

An assembly of a pair of edging panels 18 using a gusset assembly 24 comprising a gusset member 26, a base plate 28 and a locking member 30 shall now be described with reference to FIGS. 10 to 14.

FIG. 10 shows an initial step of the assembly, in which the mating faces 40 of respective end flanges 36 of the edging panels 18 are brought into engagement such that their respective end flange slots 42 are aligned. It is noted that the respective triangular openings 44 and circular openings 46 of the end flanges 36 will also be aligned if the slots are correctly aligned. It is clear from FIG. 10 that the respective upper longitudinal flanges 34 of the edging panels 18 abut one another directly and extend in a common plane, to produce a substantially continuous surface with a seamless interface from one panel 18 to the next.

With reference to FIG. 11, the locking flanges 62 of the gusset member 26 are inserted through each pair of aligned end flange slots 42 simultaneously. FIG. 11 shows the gusset member 26 and base plate 28 as assembled in advance, in other implementations the base plate 28 may be fitted to the gusset member 26 after coupling the gusset member 26 to the edging panels 18.

Referring to FIG. 12, once the locking flanges 62 are fully inserted through the end flange slots 42, the locking member 30 is positioned on the locking flanges 62 by passing each locking flange 62 through a respective one of the engagement apertures 80 of the locking member 30. This is achieved by manipulating the locking member 30 via the handle 78, which is therefore at the rear of the locking member 30 as viewed in FIG. 12.

More specifically, the locking member 30 is manipulated such that the locking flanges 62 are first inserted into the space between the engagement arms 86 and the outer edges 84 of the respective engagement apertures 80 and then, through further manipulation, the engagement arms 86 of the engagement apertures 80 are inserted into the respective engagement slots 64 of the locking flanges 62. Once fully inserted such that the fingers 90 are entirely pushed through the engagement slots 64, the locking member 30 is then pressed downwardly such that the arms 86 are driven into the lower tapered portions of the engagement slots 64 in which the surfaces converge. The resulting wedging interaction between the arms 86 and the engagement slots 64 as the locking member 30 moves down progressively generates frictional interference and local deformation of the contacting surfaces of the engagement arms 86 and slots that creates a retaining force that fastens the arms 86 in the slots.

Meanwhile, the upper ends of the locking flanges 62 locate between the guide formations 92 and the inner edges 82 of the respective engagement apertures 80, to support the upper ends of the locking flanges 62 and to hold the flanges in a vertical orientation.

The locking flanges 62, end flange slots 42, engagement apertures 80 and engagement arms 86 may be all dimensioned in a complementary manner to produce the above described interaction as they are pressed together.

In some implementations, to produce the required clamping force between the engagement arms 86 and the tapering engagement slots 64, a mallet or similar may be used to urge the locking member 30 downwardly, this being the only tool required to assemble the edging system 16. As the gusset member 26 and locking member 30 secure at three positions simultaneously, conveniently each pair of edging panels 18 can be joined in a single operation. This sits in marked contrast with conventional systems requiring multiple bolts at each interface between panels 18.

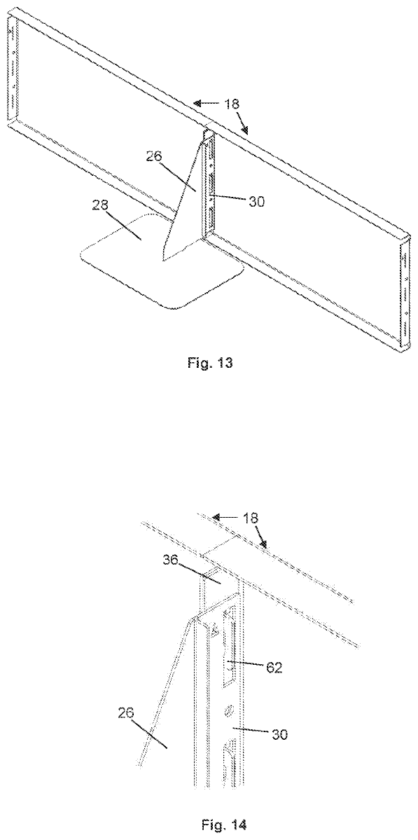

FIG. 13 shows the final stage of the assembly process in an implementation of the present disclosure, with FIG. 14 offering a detail view of the interface between the uppermost locking flange 62 and the corresponding engagement aperture 80 at this stage. Referring to FIGS. 13 and 14 the locking member 30 may be fully pressed down, such that the engagement arms 86 are lodged in the narrowed regions of the engagement slots 64 and are thus fully engaged, while the upper ends of the locking flanges 62 are close to or abut the upper edges of the engagement apertures 80. This final position defines a locked position for the locking member which may be confirmed by checking that the respective alignment apertures of the locking member 30, end flanges 36 and gusset member 26 are aligned. Once confirmed, installation of the gusset assembly 24 is complete and the edging panels 18 are joined, the locking member 30 being self-retaining at this stage due to frictional engagement between its engagement arms 86 with the engagement slots 64 of the gusset member locking flanges 62. Subsequent filling of the planting area 14 with soil, for example, will weigh the base plate 28 down and thus anchor the arrangement to create a robust boundary wall 12 for the planter 10.

It will be appreciated that many alterations may be made to the implementations of the present disclosure described above and shown in the Figures, even beyond those already discussed in the description, while still falling within the scope of the claims.

For example, the size and shape of the edging panels may be varied to suit each application, including the option of providing edging panels having curved planter walls.

In some implementations, the locking engagement between the locking member and the gusset member may be achieved in various other ways. For example, the gusset member may comprise flanges or alternative locking protrusions presenting a vertical series of holes of progressively decreasing size, through which a locking member in the form of a tapered rod may be inserted for a press fit in each hole. Equally, where there are multiple locking protrusions it may only be necessary to create a retaining force with one of them to secure the locking member, the other protrusions nonetheless providing support to the locking member and ensuring correct alignment.

The base plate and the gusset member may also be implemented in alternative ways. For example, the base plate may be integrated with the bottom longitudinal flange of an edging panel. Similarly, the end flanges may be enlarged to perform the function of the gusset member, whilst a smaller connector assembly may be used to join engaged end flanges of adjacent edging panels.

1.-38. (canceled)

39. A planter edging system comprising:
a set of edging panels arranged for end-to-end engagement to form at least part of a boundary of a planting area, each edging panel including a planter wall having an inner surface configured to be exposed to contents of the planting area, the inner surface having a pair of longitudinal edges connected by side edges, and a respective end flange extending along each side edge of the inner surface of the planter wall, each end flange defining an outwardly-directed mating face arranged to engage a corresponding mating face of an adjacent edging panel, each mating face including multiple locking apertures;
a gusset configured to be anchored within the planting area and configured to hold one or more of the edging panels upright;
a panel connector including multiple locking protrusions, each locking protrusion being arranged for insertion through a respective pair of aligned locking apertures of engaged end flanges of adjacent edging panels; and
a locking member arranged to engage at least one of the locking protrusions of the panel connector to resist retraction of the at least one of the locking protrusions through the respective locking apertures.

40. The planter edging system of claim 39, wherein the locking member is configured to engage the at least one of the locking protrusions by wedging interaction.

41. The planter edging system of claim 39, wherein the locking member is arranged for a press-fit with the at least one of the locking protrusions.

42. The planter edging system of claim 39, wherein the locking member comprises one or more locking member apertures, each of the one or more locking member apertures being arranged to receive a respective one of the locking protrusions and comprising a formation arranged to engage an opening in the respective one of the locking protrusions.

43. The planter edging system of claim 42, wherein the opening has converging sides to define a tapered profile, and wherein the formation is arranged to be pressed into progressive engagement with the converging sides of the opening of the respective one of the locking protrusions to generate a retention force that holds the locking member in engagement with the respective one of the locking protrusions.

44. The planter edging system of claim 39, wherein the locking member is configured to engage each locking protrusion of the panel connector.

45. The planter edging system of claim 39, wherein each locking aperture comprises an elongate slot.

46. The planter edging system of claim 45, wherein each locking aperture is elongate in a direction substantially parallel to the respective side edge of the edging panel.

47. The planter edging system of claim 45, wherein each locking protrusion comprises a tab.

48. The planter edging system of claim 39, wherein the panel connector comprises a connector plate from which the locking protrusions extend.

49. The planter edging system of claim 39, wherein each end flange comprises at least one alignment aperture configured to be arranged to align with a corresponding alignment aperture of an adjacent edging panel.

50. The planter edging system of claim 49, wherein at least one alignment aperture of each end flange is non-circular.

51. The planter edging system of claim 50, wherein at least one alignment aperture of each end flange is polygonal.

52. The planter edging system of claim 49, wherein the locking member comprises at least one alignment aperture that is configured to align with corresponding alignment apertures in the associated engaged end flanges when the locking member is in a locked position.

53. The planter edging system of claim 49, wherein the panel connector comprises at least one alignment aperture configured to align with corresponding alignment apertures in the associated end flanges when the locking protrusions are fully inserted into the locking apertures.

54. The planter edging system of claim 39, comprising a base plate configured to be arranged to be loaded by contents of the planting area to anchor the gusset.

55. The planter edging system of claim 54, wherein the base plate is arranged to engage a surface on which the planter edging system is installed.

56. The planter edging system of claim 54, wherein at least one of the base plate and the gusset comprises a formation enabling coupling of the base plate and the gusset.

57. The planter edging system of claim 56, wherein the gusset comprises a protrusion that is arranged to be received in an opening of the base plate to couple the gusset to the base plate.

58. The planter edging system of claim 54, wherein the base plate is integral with the gusset.

59. The planter edging system of claim 54, wherein the base plate is integral with one of the edging panels.

60. The planter edging system of claim 54, comprising a set of base plates having a combined surface area that is at least 40% of a combined surface area of the planter walls of the set of edging panels.

61. The planter edging system of claim 60, wherein the set of base plates have a combined surface area that is at least half of a combined surface area of the planter walls of the set of edging panels.

62. The planter edging system of claim 39, wherein the panel connector is integral with the gusset.

63. The planter edging system of claim 39, wherein the gusset is integral with an end flange of one of the edging panels.

64. The planter edging system of claim 39, wherein each edging panel comprises a longitudinal flange extending along a longitudinal edge of the edging panel.

65. The planter edging system of claim 64, wherein respective longitudinal flanges of engaged edging panels are configured to abut.

66. The planter edging system of claim 64, wherein each longitudinal flange is substantially orthogonal to its associated end flanges.

67. The planter edging system of claim 39, wherein each end flange is substantially orthogonal to the inner surface of the associated planter wall.

68. The planter edging system of claim 39, wherein one or more of the edging panels, the locking member, the gusset and the panel connector are formed from sheet metal.

69. The planter edging system of claim 39, wherein the inner surface of the planter wall of at least one of the edging panels is substantially planar.

70. The planter edging system of claim 39, wherein respective outer surfaces of the planter walls of engaged edging panels are configured to be substantially continuous with each other.

71. A planter edging system comprising:
a set of edging panels arranged for end-to-end engagement to form at least part of a boundary of a planting area, each edging panel including
a planter wall having an inner surface configured to be exposed to contents of the planting area, the inner surface having a pair of longitudinal edges connected by side edges and a respective end flange extending along each side edge of the inner surface of the planter wall, each end flange defining an outwardly-directed mating face arranged to engage a corresponding mating face of an adjacent edging panel;
a set of panel connector assemblies, each panel connector assembly being configured to lock a respective pair of engaged end flanges of adjacent edging panels together;
a set of base plates configured to be arranged to be loaded by contents of the planting area, wherein the base plates of the set have a combined surface area that is at least 40% of a combined surface area of the inner surfaces of the edging panel planter walls; and
a set of gussets that are each configured to be anchored to a respective base plate, each gusset being configured to hold one or more of the edging panels upright.

72. The planter edging system of claim 71, wherein the set of base plates have a combined surface area that is at least half of a combined surface area of the planter walls of the set of edging panels.

73. A method of constructing a planter edging system, the system comprising a set of edging panels arranged for end-to-end engagement to form at least part of a boundary of a planting area, each edging panel comprising end flanges defining respective outwardly-directed mating faces arranged to engage corresponding mating faces of adjacent edging panels, each mating face including multiple locking apertures, the method comprising:
anchoring a gusset connected to one or more of the edging panels within the planting area; engaging the respective mating faces of adjacent edging panels such that the locking apertures of the respective end flanges align;
inserting multiple locking protrusions of a panel connector through respective pairs of aligned locking apertures simultaneously; and
engaging a locking member with at least one of the locking protrusions to resist subsequent retraction of the or each locking protrusion through the respective locking apertures.

74. A method for making a planter edging system, the system comprising a set of edging panels arranged for end-to-end engagement to form at least part of a boundary of a planting area, the method comprising:
cutting a blank for a first edging panel from a piece of sheet material;
cutting a blank for a second edging panel from a piece of sheet material;
folding each of the blanks for the first and second edging panels so that each of the edging panels define:
a planter wall having an inner surface exposed to contents of the planting area, in use, the inner surface having a pair of longitudinal edges connected by side edges; and
a respective end flange extending along each side edge of the inner surface of the planter wall, each end flange defining an outwardly-directed mating face arranged to engage a corresponding mating face of an adjacent edging panel, each mating face including multiple locking apertures;
cutting a blank for a gusset from a piece of sheet material;
cutting a blank for a panel connector from a piece of sheet material, and folding the blank to define multiple locking protrusions, each locking protrusion being arranged for insertion through a respective pair of aligned locking apertures of engaged end flanges of adjacent edging panels; and
cutting a blank for a locking member from a piece of sheet material, the locking member being arranged to engage at least one of the locking protrusions of the panel connector to resist retraction of the or each locking protrusion through the respective locking apertures.

75. A method of constructing a planter edging system, the system comprising a set of edging panels arranged for end-to-end engagement to form at least part of a boundary of a planting area, each edging panel comprising end flanges defining respective outwardly-directed mating faces arranged to engage corresponding mating faces of adjacent edging panels, the method comprising:
engaging the respective mating faces of adjacent edging panels;
locking the engaged end flanges of adjacent edging panels together;
loading a set of base plates with contents of the planting area, such that a combined loaded surface area of the base plates corresponds to at least 40% of a combined surface area of the inner surfaces of the edging panel planter walls; and
anchoring a respective gusset to each base plate, each gusset being connected to one or more of the edging panels to hold the or each edging panel upright.

76. A method for making a planter edging system, the system comprising a set of edging panels arranged for end-to-end engagement to form at least part of a boundary of a planting area, a set of gussets that are each configured to hold one or more of the edging panels upright, in use, and a set of base plates arranged to be loaded by contents of the planting area, the method comprising:
cutting a blank for a first edging panel from a piece of sheet material;
cutting a blank for a second edging panel from a piece of sheet material;
folding each of the blanks for the first and second edging panels so that each of the edging panels define:
a planter wall having an inner surface exposed to contents of the planting area, in use, the inner surface having a pair of longitudinal edges connected by side edges; and
a respective end flange extending along each side edge of the inner surface of the planter wall, each end flange defining an outwardly-directed mating face arranged to engage a corresponding mating face of an adjacent edging panel;
for each gusset of the set, cutting a blank for the gusset from a piece of sheet material; and
for each base plate of the set, cutting a blank for the base plate from a piece of sheet material, such that the base plates of the set have a combined surface area that is at least 40% of a combined surface area of the inner surfaces of the edging panel planter walls.
